(19) United States
(12) Patent Application Publication
(10) Pub. No.: US 2013/0298340 A1
(43) Pub. Date: Nov. 14, 2013

(54) ELECTRIC TOOTHBRUSH

(71) Applicant: Saksit Suwanbutr, Bangkok (TH)

(72) Inventor: Saksit Suwanbutr, Bangkok (TH)

(21) Appl. No.: 13/894,073

(22) Filed: May 14, 2013

Related U.S. Application Data
(60) Provisional application No. 61/646,850, filed on May 14, 2012.

(51) Int. Cl. A61C 17/26

(52) U.S. Cl. CPC A61C 17/26
USPC 15/23; 15/22.1

(57) ABSTRACT

An electric toothbrush having a central longitudinal axis is disclosed. The electric toothbrush has a brush head having a bristle roll shaft with a plurality of bristle tufts radially and outwardly disposed thereon, thereby forming a bristle roll covered by the cover member. The bristle roll shaft, the horizontal drive shaft and the central drive shaft are operatively connected by a belt and pulley system and a bevel gear system, causing the bended or angle feature of the toothbrush head. The central drive shaft and the horizontal drive shaft cause a one-way forward rotating motion of the bristle roll. This rotating motion and direction simulates the brushing technique recommended by most dentists to the conventional manual toothbrush users.

This application claims priority to U.S. Provisional Application 61/646,850 filed on May 14, 2012, the entire disclosure of which is incorporated by reference.

### BACKGROUND OF THE INVENTION

1. Field of the Invention

The present invention is a toothbrush. More specifically, the present invention is an electric toothbrush.

2. Description of the Related Art

Traditional electric toothbrushes do not simulate a proper brushing technique using a manual toothbrush as recommended by most dentists. Typically traditional toothbrushes have a rotational oscillation which is a back and forth motion at a relatively high speed.

The present invention has a one-way forward rotating motion that can simulate a proper brushing technique at a relatively low speed as utilizing a conventional manual toothbrush recommended by most dentists, especially on the lingual surface or inner surface and the buccal surface or outer surface of a user's lower and upper anterior teeth.

### BRIEF SUMMARY OF THE INVENTION

The present invention is a toothbrush. More specifically, the present invention is an electric toothbrush.

The electric toothbrush includes a support handle housing having a push button control switch disposed on an outer surface of the support handle housing, a first spur gear coupled to an output end of a motor drive shaft, the first spur gear is operatively connected to a second spur gear which is coupled at a first end of a central drive shaft disposed in a center portion of a neck and a motor energized by a battery disposed within the support handle housing and a second end of a central drive shaft is coupled to a first bevel gear. The electric toothbrush also includes a brush support housing coupled to the support handle housing, the brush support housing includes the neck and a head and a bristle roll that is protected by a cover member disposed over the head covering the bristle roll.

The electric toothbrush has a bristle roll which rotates along an axis perpendicular to a longitudinal axis of a neck of the electric toothbrush. The electric toothbrush has a brushing stroke only in a one-way forward direction to brush teeth and gums from a user's gum line along an axis of tooth length to a tip of a tooth at a relatively low speed as using a conventional manual toothbrush. The electric toothbrush simulates proper brushing technique, follows the direction of tooth eruption, especially on a lingual surface or an inner surface and a buccal surface or an outer surface of lower and upper anterior teeth and produces a movement similar to a conventional manual toothbrush recommended by most dentists.

The electric toothbrush is different from a traditional electric toothbrush since most electric toothbrushes produce a circular reciprocating or oscillating motion utilized together with other motions. And the electric toothbrush provides a rubbing motion onto a tooth surface and a gum margin. The electric toothbrush has a vertical, one-way, forward, up or down direction of brushing stroke at a relatively low speed that is similar to a conventional manual toothbrush motion.

It is an object of the present invention to provide an electric toothbrush that provides a bristle roll shaft disposed at a head of the electric toothbrush having a plurality of tufts of bristles extending radially and outwardly from a bristle roll shaft forming a bristle roll.

It is an object of the present invention to provide an electric toothbrush that has a horizontal drive shaft disposed between and paralleled to a bristle roll shaft and perpendicular to a central drive shaft of a neck of the electric toothbrush.

It is an object of the present invention to provide an electric toothbrush that has a bristle roll shaft, a horizontal drive shaft and a central drive shaft of a neck operatively connected to each other's by a belt and pulley system and a bevel gear system forming a bended or angle feature at the head.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side view of an electric toothbrush, in accordance with one embodiment of the present invention.

FIG. 2 illustrates a rear view of an electric toothbrush, in accordance with one embodiment of the present invention.

FIG. 3 illustrates a front view of an electric toothbrush, in accordance with one embodiment of the present invention.

FIG. 4 illustrates a side view of an electric toothbrush, in accordance with one embodiment of the present invention.

FIG. 5 illustrates a rear view of an electric toothbrush, in accordance with one embodiment of the present invention.

FIG. 6 illustrates a side view of an electric toothbrush, in accordance with one embodiment of the present invention.

FIG. 7 illustrates a rear view of an electric toothbrush, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

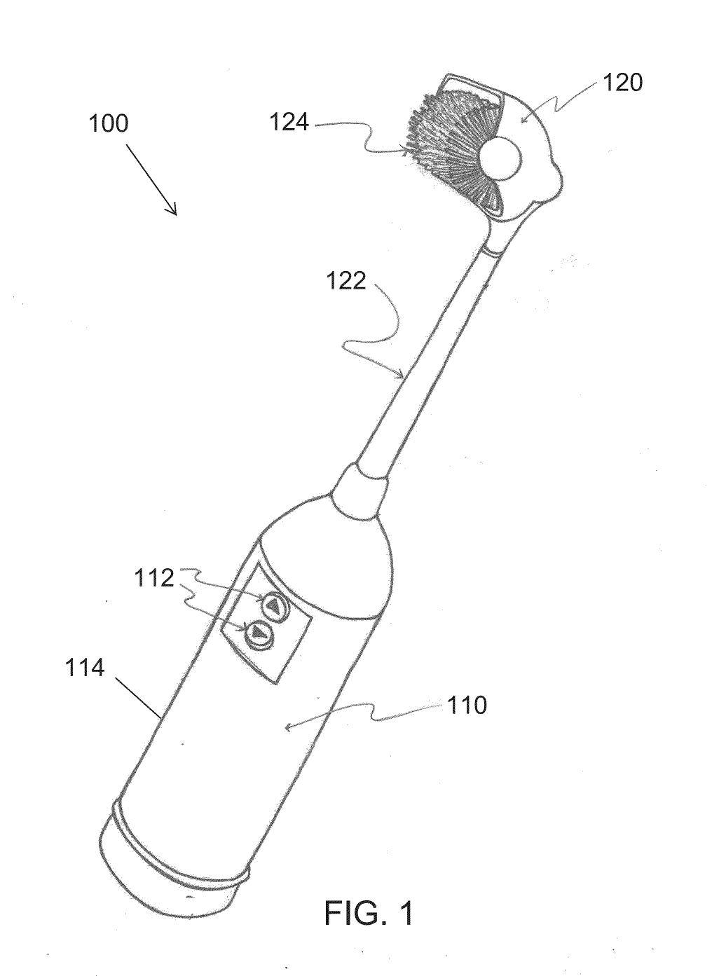

FIG. 1 illustrates a side view of an electric toothbrush 100, in accordance with one embodiment of the present invention.

The electric toothbrush 100 includes a support handle housing 110 and a brush support housing 120 with a neck 122 and a head 124. The support handle housing 110 is coupled to the brush support housing 120. More specifically, the brush support housing 120 can be detached from the support handle housing 110.

A push button control switch 112 can be disposed on an outer surface 114 of the support handle housing 110.

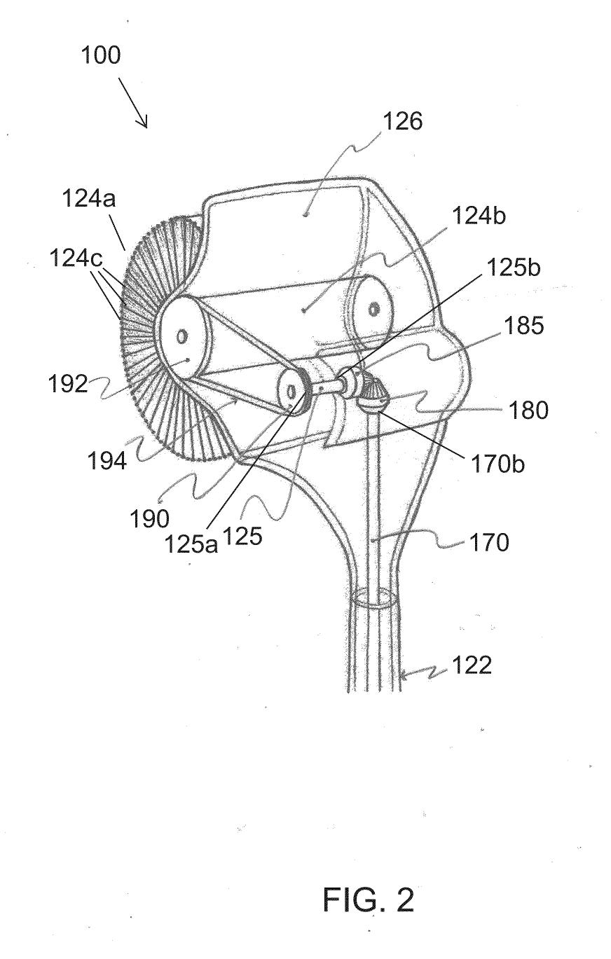

FIG. 2 illustrates a rear view of an electric toothbrush 100, in accordance with one embodiment of the present invention.

The head 124 has a plurality of tufts of bristles 124c extended radially and outwardly from the bristle roll shaft 124b to form a bristle roll 124a. A second end 170b of the central drive shaft 170 can be coupled to a first bevel gear 180. The first bevel gear 180 can be operatively connected to a second bevel gear 185 which can be coupled to the second end 125b of the horizontal drive shaft 125, which is paralleled to the bristle roll shaft 124b and perpendicular to the central drive shaft of the neck 170. There can be a first smaller pulley 190 coupled to the first end 125a of the horizontal drive shaft 125, which can be operatively connected to the second bigger pulley 192 coupled to the first end of the bristle roll shaft 124b by a belt 194. And this configuration causes the invention having an angle or bended feature at the head 124 of the electric toothbrush 100.

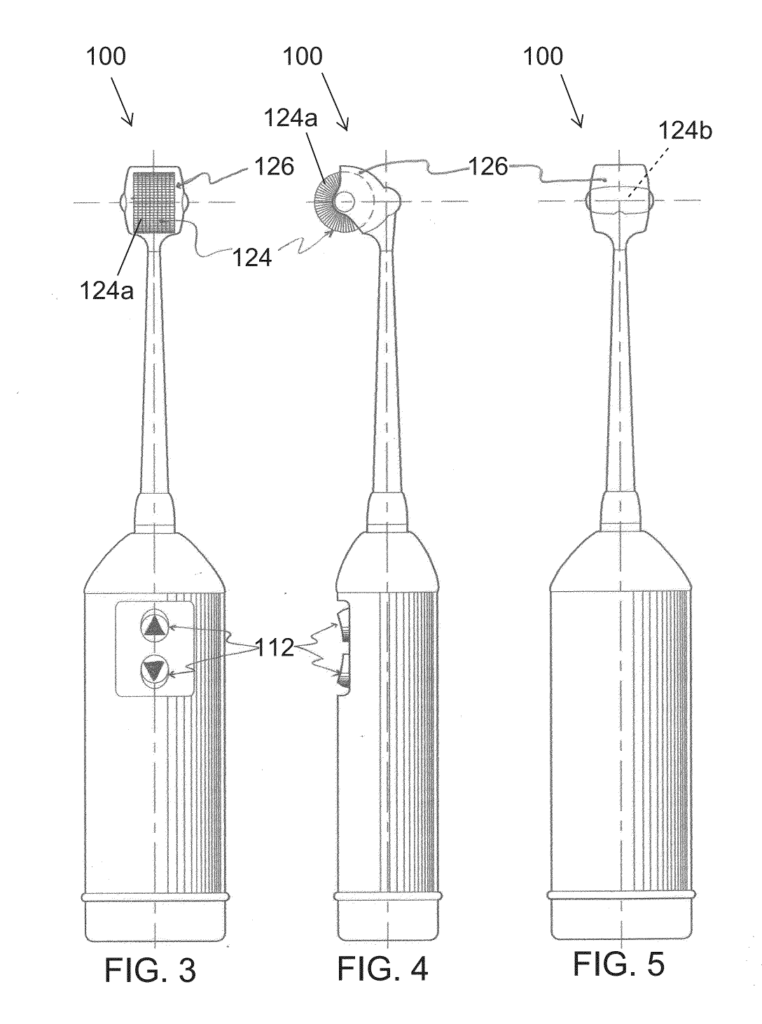

FIG. 3 illustrates a front view of an electric toothbrush 100, in accordance with one embodiment of the present invention.

The head 124 has a plurality of tufts of bristles 124c extended radially and outwardly from the bristle roll sharp 124b forming a bristle roll 124a.

FIG. 4 illustrates a side view of an electric toothbrush 100, in accordance with one embodiment of the present invention.

The bristle roll 124a can be protected by a cover member 126 which can be disposed over the head 124 covering the full length of the bristle roll 124a.

FIG. 5 illustrates a rear view of an electric toothbrush 100, in accordance with one embodiment of the present invention.

The cover member 126 protects the bristle roll 124a of the electric toothbrush 100 to prevent tissues in a user's oral cavity (not shown) from being injured from the tufts of bristles 124c of the bristle roll 124a during the rotating brushing motion of the electric toothbrush 100 against a user's teeth and gums (not shown).

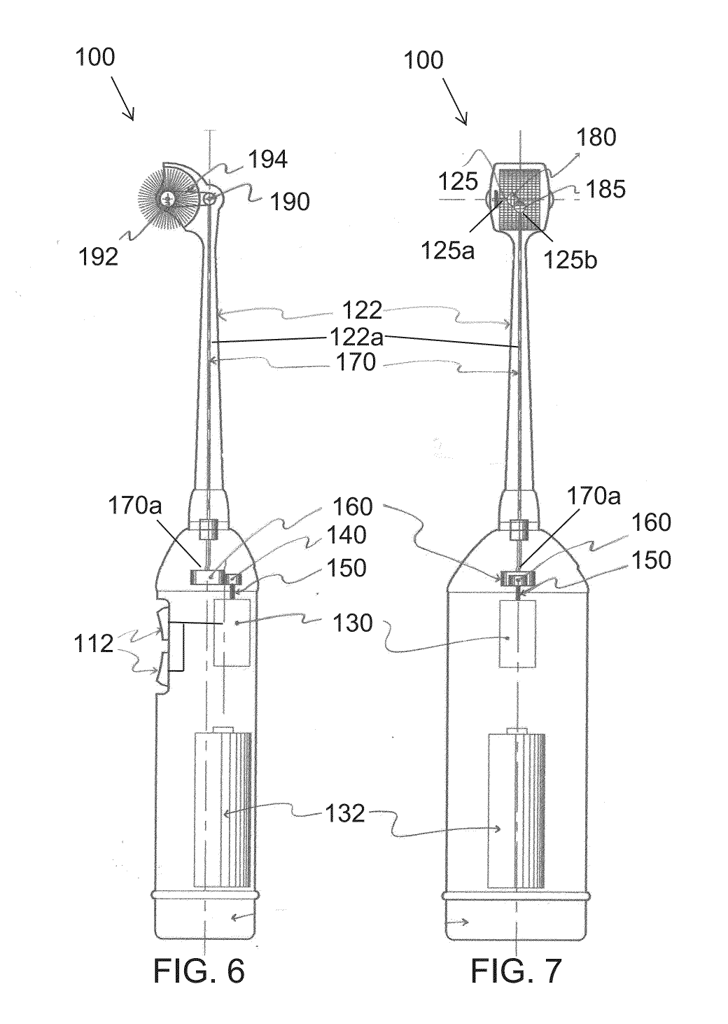

FIG. 6 illustrates a side view of an electric toothbrush 100, in accordance with one embodiment of the present invention. There can be a first spur gear 140 coupled to an output end of a motor drive shaft 150. The first spur gear 140 is operatively connected to a second spur gear 160 which can be coupled at a first end 170a of a central drive shaft 170 disposed in a center portion 122a of the neck 122 of the electric toothbrush 100. There can be a motor 130 energized by a battery 132 disposed within the support handle housing 110. The push button control switch 112, the motor 130 and the battery 132 can be electrically connected to each other by an electrical circuit (not shown).

FIG. 7 illustrate a rear view of an electric toothbrush, in accordance with one embodiment of the present invention. The push button control switch 112 controls the motor 130 to start or to stop the electric toothbrush 100 and to rotate clockwise, counter-clockwise, to rotate in an interrupted motion, in a continuous motion or in a predetermined period of time such as 5 seconds or other suitable period of time.

The rotating power of the electric toothbrush is generated by the battery energized motor disposed in the hollow cavity of the handle. The rotating power of the motor is transferred through the spur gear system from the output end of the motor drive shaft to the central drive shaft of the neck. The electric toothbrush includes two spur gears. The primary smaller spur gear is attached at the output end of the motor drive shaft. The secondary bigger spur gear is attached at the frontal end of the central drive shaft. The rotating power is provided to the central drive shaft transfers through the bevel gear system causing the horizontal drive shaft to rotate. The rotating power of the horizontal drive shaft transfers to the bristle roll shaft through the belt and pulley system causing the bristle roll shaft to rotate. The belt and pulley system includes two pulleys of differing diameter disposed separately from each other at the head of the electric toothbrush. The smaller pulley is attached at the first end of the horizontal drive shaft. The bigger pulley is attached at the first end of the bristle roll shaft. Both pulleys are operatively connected by a belt.

The electric toothbrush is utilized for cleaning teeth and gums properly and effectively by simulating the proper brushing technique using a conventional manual toothbrush as recommended by most dentists. It is very accessible and very convenient to utilize the angle or bended feature of the head of the electric toothbrush to clean teeth where they are difficult to clean, especially on the inner surface of the upper and lower anterior or front teeth. It is also accessible to utilize the electric toothbrush to clean the occlusal or top surface of the teeth and the top surface of the tongue. Because of its rotating motion which follows the direction of tooth eruption, the electric toothbrush causes only a minimal abrasion to tooth structure and a minimal recession to the gum margin.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. An electric toothbrush, comprising:
a support handle housing having a push button control switch disposed on an outer surface of the support handle housing; and
a brush support housing coupled to the support handle housing, the brush support housing includes a neck and a head, the head has a plurality of tufts of bristles forming a bristle roll disposed on the head.

2. The electric toothbrush according to claim 1, further comprising a first spur gear coupled to an output end of a motor drive shaft, the motor drive shaft is coupled to a second spur gear which is coupled at a first end of a central drive shaft disposed in a center portion of the neck.

3. The electric toothbrush according to claim 1, further comprising a motor energized by a battery disposed within the support handle housing.

4. The electric toothbrush according to claim 1, further comprising a second end of a central drive shaft coupled to a first bevel gear.

5. The electric toothbrush according to claim 4, wherein the first bevel gear is operatively connected to a second bevel gear which is coupled to a second end of the horizontal drive shaft and a first smaller pulley is coupled to a first end of a horizontal drive shaft, the first smaller pulley is operatively connected to a second bigger pulley which is coupled to the first end of the bristle roll shaft by a belt.

6. The electric toothbrush according to claim 1, wherein the push button control switch, the motor and the battery are electrically connected by an electrical circuit.

7. The electric toothbrush according to claim 1, wherein the bristle roll is protected by a cover member, the cover member is disposed over the head covering the bristle roll.

8. An electric toothbrush, comprising:
a support handle housing having a push button control switch disposed on an outer surface of the support handle housing; and
a brush support housing coupled to the support handle housing, the brush support housing includes a neck and a head, the head to form a bristle roll, the bristle roll is protected by a cover member and the cover member is disposed over the head covering the bristle roll.

9. The electric toothbrush according to claim 8, further comprising a first spur gear coupled to an output end of a motor drive shaft, the first spur gear is operatively connected to a second spur gear which is coupled at a first end of a central drive shaft disposed in a center portion of the neck.

10. The electric toothbrush according to claim 8, further comprising a motor energized by a battery disposed within the support handle housing.

11. The electric toothbrush according to claim 8, further comprising a second end of a central drive shaft coupled to a first bevel gear.

12. The electric toothbrush according to claim 11, wherein the first bevel gear is operatively connected to a second bevel gear which is coupled to a second end of a horizontal drive shaft and a first smaller pulley is coupled to a first end of the horizontal drive shaft, the first smaller pulley is operatively connected to a second bigger pulley which is coupled to the first end of the bristle roll shaft by a belt.

13. The electric toothbrush according to claim 8, wherein the push button control switch, the motor and the battery are electrically connected by an electrical circuit.

14. The electric toothbrush according to claim 8, wherein the cover member protects the bristle roll to prevent tissues in a user's oral cavity from being injured from a plurality of tufts of bristles during a rotating brushing motion of the electric toothbrush against a user's teeth and gums.

15. The electric toothbrush according to claim 14, wherein the tufts of bristles extend radially and outwardly from the bristle roll shaft to form the bristle roll.

16. An electric toothbrush, comprising:
a support handle housing having a push button control switch disposed on an outer surface of the support handle housing, a first spur gear coupled to an output end of a motor drive shaft, the first spur gear is operatively connected to a second spur gear which is coupled to a first end of a central drive shaft disposed in a center portion of a neck, a motor energized by a battery disposed within the support handle housing, a second end of a central drive shaft coupled to a first bevel gear and the first bevel gear is operatively connected to a second bevel gear coupled to a second end of the horizontal drive shaft and a first smaller pulley coupled to a first end of a horizontal drive shaft is operatively connected to a second bigger pulley which is coupled to a first end of the bristle roll shaft by a belt, the push button control switch, the motor and the battery are electrically connected by an electrical circuit; and
a brush support housing coupled to the support handle housing, the brush support housing includes the neck and a head, the head to form a bristle roll, the bristle roll is protected by a cover member and the cover member is disposed over the head covering the bristle roll.

17. The electric toothbrush according to claim 16, wherein the brush support housing is detached from the support handle housing.

18. The electric toothbrush according to claim 16, wherein the push button control switch controls the motor to start or to stop the electric toothbrush and to rotate clockwise, counter-clockwise, to rotate in an interrupted motion, in a continuous motion or during a predetermined period of time.

19. The electric toothbrush according to claim 16, wherein the cover member protects the bristle roll to prevent tissues in a user's oral cavity from being injured from a plurality of tufts of bristles during a rotating brushing motion of the electric toothbrush against a user's teeth and gums.

20. The electric toothbrush according to claim 19, wherein the tufts of bristles extend radially and outwardly from the bristle roll shaft to form the bristle roll at one or more various angles and in one or more lengths or one or more heights.
